(19) United States
(12) Patent Application Publication
(10) Pub. No.: US 2016/0027050 A1
(43) Pub. Date: Jan. 28, 2016

(54) METHOD OF PROVIDING ADVERTISEMENT SERVICE USING CLOUD ALBUM

(71) Applicant: SEERSLAB, INC., Seoul (KR)

(72) Inventor: Jin Wook CHONG, Seoul (KR)

(21) Appl. No.: 14/788,428

(22) Filed: Jun. 30, 2015

(30) Foreign Application Priority Data
Jul. 24, 2014 (KR) 10-2014-0094088

(51) Int. Cl. G06Q 30/02

(52) U.S. Cl. CPC G06Q 30/0255; G06Q 30/0275

(57) ABSTRACT

A method of providing advertisement service using a cloud album executed by a computer is disclosed herein. In this method, a stored image is received from a terminal of a user. A cloud album corresponding to the user is configured. At least one image stored in the cloud album is analyzed in order to derive the behavioral characteristic of the user. At least one target advertisement is selected from a plurality of previously stored advertisements based on the derived behavioral characteristic of the user. The at least one target advertisement is provided to the terminal of the user.

### CROSS-REFERENCE TO RELATED APPLICATION

This application claims the benefit of Korean Patent Application No. 10-2014-0094088, filed Jul. 24, 2014, which is hereby incorporated by reference herein in its entirety.

### BACKGROUND

1. Technical Field

The present invention relates generally to a technology regarding a method of providing advertisement service to a terminal of a user using a cloud album and, more particularly, to a method of providing at least one target advertisement to a terminal of a user based on the behavioral characteristic of the user, which has been derived using at least one image stored in a cloud album.

2. Description of the Related Art

Conventional technologies for providing advertisement service to terminals of users provide arbitrary advertisements to the terminals of the users without considering the behavioral characteristics of the users. In this case, the behavioral characteristics of users refer to characteristics, such as the race, nationality, gender, age, job, hobbies or interests of the users.

Accordingly, the conventional technologies for providing advertisement service to terminals of users are disadvantageous in that they achieve poor advertisement effects because they provide arbitrary advertisements for which the behavioral characteristics of the users have not been considered.

The present invention proposes a technology for maximizing an advertisement effect by providing at least one target advertisement to a terminal of a user based on the behavioral characteristic of the user which has been derived using at least one image stored in a cloud album that operates in conjunction with the terminal of the user.

### SUMMARY

At least one embodiment of the present invention is directed to the provision of a method of providing advertisement service, which maximizes an advertisement effect by providing at least one target advertisement to a terminal of a user based on the behavioral characteristic of the user that has been derived using a cloud album.

At least one embodiment of the present invention is directed to the provision of a method of providing advertisement service, which derives the behavioral characteristic of a user by analyzing at least one image stored in a cloud album.

At least one embodiment of the present invention is directed to the provision of a method of providing advertisement service, which analyzes at least one image based on at least one of a subject and a background included in the at least one image.

At least one embodiment of the present invention is directed to the provision of a method of providing advertisement service using various display methods in the process of providing at least one target advertisement to a terminal of a user.

In accordance with an aspect of the present invention, there is provided a method of providing advertisement service using a cloud album executed by a computer, the method including: receiving a stored image from a terminal of a user, and configuring a cloud album corresponding to the user; analyzing at least one image stored in the cloud album in order to derive a behavioral characteristic of the user; selecting at least one target advertisement from a plurality of previously stored advertisements based on the derived behavioral characteristic of the user; and providing the at least one target advertisement to the terminal of the user.

Selecting the at least one target advertisement may include selecting the at least one target advertisement by taking into account the derived behavioral characteristic of the user and a bidding price of each of the plurality of advertisements.

Analyzing the at least one image stored in the cloud album may include recognizing at least one of a subject and a background included in the at least one image stored in the cloud album, and deriving the behavioral characteristics of the user based on a result of the recognition.

Deriving the behavioral characteristic of the user based on the result of the recognition may include classifying the at least one of the recognized subject and background included in the at least one image based on predetermined categories.

Recognizing the at least one of the subject and the background included in the at least one image stored in the cloud album may include recognizing the at least one of the subject and the background included in the at least one image based on a folder of the cloud album in which the at least one image is stored.

Analyzing the at least one image stored in the cloud album may include analyzing a folder of the cloud album in which the at least one image is stored.

Providing the at least one target advertisement to the terminal of the user may include displaying the at least one target advertisement via an image view interface supported by the terminal of the user.

Displaying the at least one target advertisement via the image view interface may include displaying the at least one target advertisement using at least one of a method of inserting the at least one target advertisement into a thumbnail on the image view interface, a method of inserting the at least one target advertisement between a plurality of images sliding on the image view interface, a method of inserting the at least one target advertisement into a collage on the image view interface, a method of overlaying the at least one target advertisement on an image provided on the image view interface, a method of inserting the at least one target advertisement into at least some region of an image provided on the image view interface, and a method of inserting the at least one target advertisement in a banner form on the image view interface.

Displaying the at least one target advertisement may include displaying the at least one target advertisement based on the derived behavioral characteristic of the user.

The method may further include calculating the capacity of the cloud album corresponding to the user, and displaying the at least one target advertisement via the image view interface may include determining at least one of the display time, display cycle, and number of displays of the at least one target advertisement based on the calculated capacity of the cloud album.

Selecting the at least one target advertisement may include extracting an advertisement characteristic of each of the plurality of previously stored advertisements, and selecting the at least one target advertisement of the plurality of previously stored advertisements by comparing the extracted advertisement characteristic of each of the plurality of previously stored advertisements with the derived behavioral characteristic of the user.

The plurality of previously stored advertisements may have at least one of text, image, sound, and moving image formats.

Providing the at least one target advertisement to the terminal of the user may include storing the provided at least one target advertisement in the terminal of the user, or providing the at least one target advertisement of at least one previously cached advertisement to the terminal of the user.

The method may further include receiving the personal information of the user from the terminal of the user, and selecting the at least one target advertisement may include selecting the at least one target advertisement from the plurality of previously stored advertisements based on the derived behavioral characteristic of the user and the received personal information of the user.

In accordance with another aspect of the present invention, there is provided a computer-readable storage medium having stored therein computer-readable program instructions that, when executed by a computer, cause the computer to perform a method, wherein the method includes receiving a stored image from a terminal of a user; configuring a cloud album corresponding to the user; analyzing at least one image stored in the cloud album in order to derive the behavioral characteristic of the user; selecting at least one target advertisement from a plurality of previously stored advertisements based on the derived behavioral characteristic of the user; and providing the at least one target advertisement to the terminal of the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a system for providing advertisement service according to an embodiment of the present invention;

FIG. 2 is a block diagram showing an advertisement service provision server according to an embodiment of the present invention;

FIG. 3 is a flowchart showing a method of providing advertisement service according to an embodiment of the present invention;

FIG. 4 is a conceptual diagram showing a process of analyzing at least one image stored in a cloud album according to an embodiment of the present invention; and

FIGS. 5 to 8 are diagrams showing screens of the terminal of a user to which at least one target advertisement is provided according to an embodiment of the present invention.

### DETAILED DESCRIPTION

Embodiments of the present invention will be described in detail below with reference to the accompanying drawings. However, the present invention is not limited or restricted by these embodiments. Furthermore, throughout the drawings, the same reference symbols designate the same components.

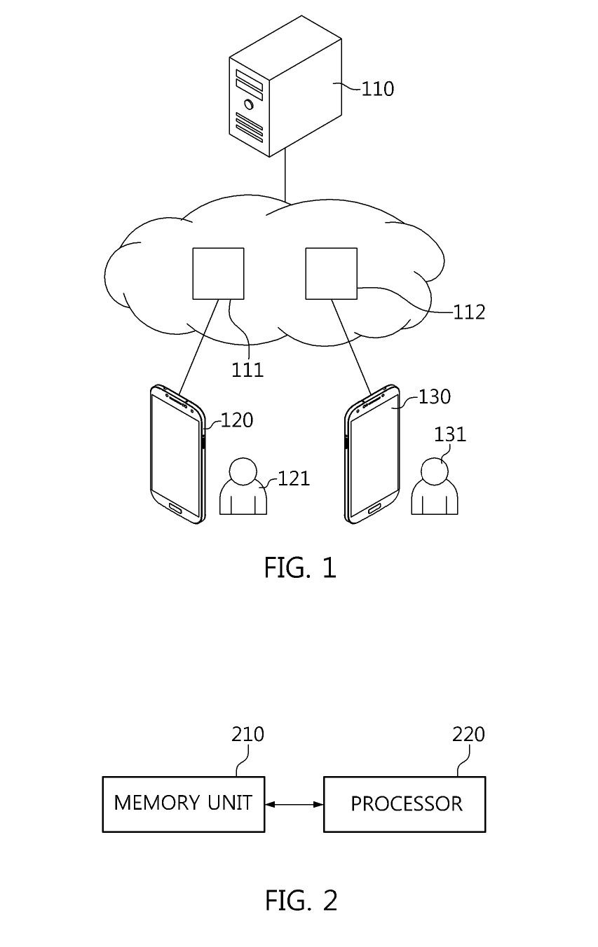

FIG. 1 is a diagram showing a system for providing advertisement service according to an embodiment of the present invention.

Referring to FIG. 1, the system for providing advertisement service according to the present embodiment includes an advertisement service provision server 110, and a terminal 120 of a user 121 connected to the advertisement service provision server 110 via a wireless or wired connection.

The advertisement service provision server 110 is a computer that constitutes part of a cloud, and may configure and maintain a cloud album 111 corresponding to the terminal 120 of the user 121. In this case, the advertisement service provision server 110 may be connected to a terminal 130 of another user 131 different from the user 121 via a wireless or wired connection as well as the terminal 120 of the user 121, and then may configure and maintain a cloud album 112 corresponding to the terminal 130 of the other user 131. As described above, the advertisement service provision server 110 may be connected to the plurality of terminals 120 and 130 via a wireless or wired connection, and then may configure and maintain the plurality of the cloud albums 111 and 112 corresponding to the plurality of the terminals 120 and 130, respectively.

The advertisement service provision server 110 may derive the behavioral characteristics of the users 121 and 131 corresponding to the terminals 120 and 130 using the cloud albums 111 and 112 corresponding to the terminals 120 and 130, and may provide the terminals 120 and 130 with advertisements suitable for the users 121 and 131 of the terminals 120 and 130.

More specifically, the advertisement service provision server 110 derives the behavioral characteristic of the user 121 by analyzing at least one image stored in the cloud album 111 corresponding to the terminal 120 of the user 121, and provides at least one target advertisement to the terminal 120 of the user 121 based on the derived behavioral characteristic of the user 121. In this case, the advertisement service provision server 110 may provide the at least one target advertisement to the terminal 120 of the user 121 using an application installed on the terminal 120 of the user 121. For example, the at least one target advertisement may be provided to the terminal 120 of the user 121 via the image view interface of the application supported by the terminal 120 of the user 121. In the following, the operation of the advertisement service provision server 110 is described as including an operation performed by the application installed on the terminal 120 of the user 121.

In the same manner, the advertisement service provision server 110 may derive the behavioral characteristic of the user 131 by analyzing at least one image stored in the cloud album 112 corresponding to the terminal 130 of another user 131, and then may provide at least one target advertisement to the terminal 130 of another user 131 based on the derived behavioral characteristic of the user 131.

In this case, the at least one target advertisement provided to the terminal 120 of the user 121 and the at least one target advertisement provided to the terminal 130 of the other user 131 may be different from each other because they are provided based on the behavioral characteristics of the users 121 and 131 of the terminals 120 and 130. However, the at least one target advertisement provided to the terminal 120 of the user 121 and the at least one target advertisement provided to the terminal 130 of the other user 131 may be the same as each other.

Accordingly, the advertisement service provision server 110 according to the present embodiment provides the plurality of terminals 120 and 130 with advertisements suitable for the users 121 and 131 of the plurality of terminals 120 and 130, thereby being able to maximize advertisement effects.

FIG. 2 is a block diagram showing an advertisement service provision server according to an embodiment of the present invention.

Referring to FIG. 2, the advertisement service provision server according to the present embodiment is a computer including a memory unit 210 and a processor 220, and may constitute part of a cloud.

The memory unit 210 stores a program running on the advertisement service provision server.

The processor 220 controls the operation of the advertisement service provision server in accordance with the program stored in the memory unit 210.

In this case, the program is a computer program configured to perform the steps of: receiving a stored image from the terminal of a user; configuring a cloud album corresponding to the user; analyzing at least one image stored in the cloud album in order to derive the behavioral characteristic of the user; selecting at least one target advertisement from a plurality of previously stored advertisements based on the derived behavioral characteristic of the user; and providing the at least one target advertisement to the terminal of the user.

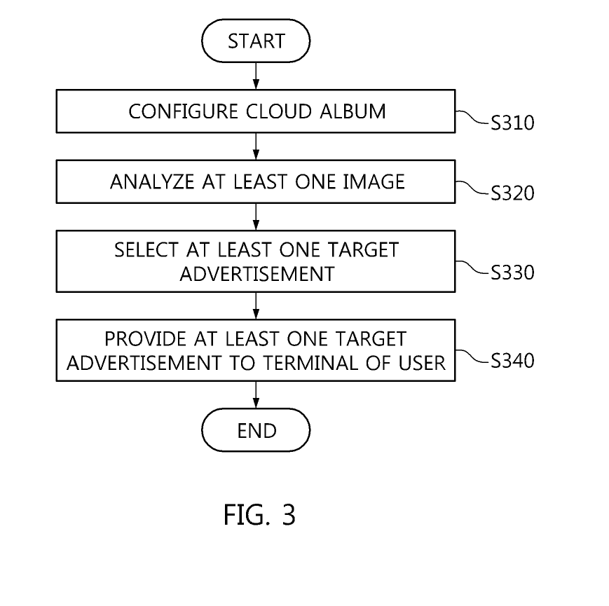

In accordance with the program, the processor 220 controls the operation of the advertisement service provision server. Accordingly, the advertisement service provision server according to the present embodiment derives the behavioral characteristic of a user by analyzing at least one image stored in a cloud album, and provides at least one target advertisement to the terminal of the user based on the derived behavioral characteristic of the user, thereby being able to maximize an advertisement effect. This is described in detail with reference to FIG. 3.

FIG. 3 is a flowchart showing a method of providing advertisement service according to an embodiment of the present invention.

Referring to FIG. 3, an advertisement service provision server according to an embodiment of the present invention receives a stored image from a terminal of a user and then configures a cloud album corresponding to the user at step S310. In this case, the advertisement service provision server may automatically receive the stored image from the terminal of the user or select the stored image in response to a request from the user, and then may configure the cloud album corresponding to the user. The cloud album refers to an album based on a storage system that is provided over the Internet or online. Furthermore, the advertisement service provision server receives a stored image from a terminal of a user, configures a cloud album using the received image, and also locally caches the stored image so that the user can view the locally cached image when a network connection is unstable or a network connection is not required.

Thereafter, in order to derive the behavioral characteristic of the user, the advertisement service provision server analyzes at least one image stored in the cloud album at step S320. More specifically, the advertisement service provision server may analyze the at least one image stored in the cloud album by recognizing at least one of a subject and a background included in the at least one image stored in the cloud album and then deriving the behavioral characteristic of the user based on the result of the recognition. For example, the advertisement service provision server may classify at least one of the recognized subject and background included in the at least one image based on predetermined categories, and then may derive the behavioral characteristic of the user. More specifically, the advertisement service provision server may classify at least one of the recognized subject and background included in the at least one image based on predetermined categories, may generate at least one behavioral characteristic word corresponding to the at least one of the subject and the background, and then may derive the behavioral characteristic of the user including the at least one behavioral characteristic word. In this case, the behavioral characteristic of the user is a characteristic that matches the advertisement characteristic of at least one target advertisement to be provided to the user, such as the race, nation, gender, age, job, hobbies or interests of the user. The behavioral characteristic may include at least one behavioral characteristic word divided and generated based on predetermined categories.

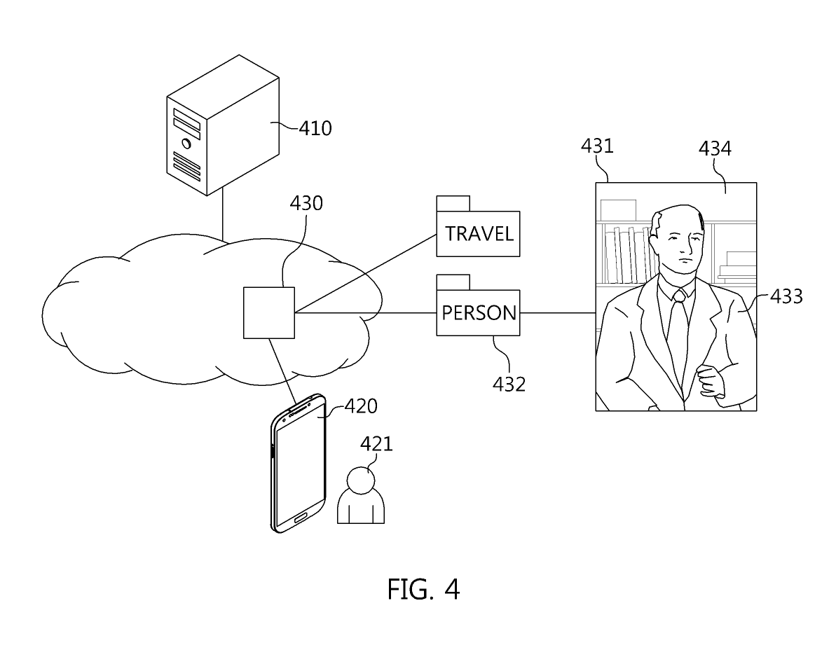

In this case, the advertisement service provision server may recognize at least one of a subject and a background included in the at least one image based on a folder of the cloud album in which the at least one image is stored. Accordingly, analyzing the at least one image stored in the cloud album may include analyzing the folder of the cloud album in which the at least one image is stored. This is described in detail with reference to FIG. 4.

Furthermore, if the number of images stored in the cloud album is plural, the advertisement service provision server may derive the behavioral characteristic of the user with respect to each of the plurality of images, may check the correlation between the plurality of behavioral characteristics of the user, and may determine the representative behavioral characteristic of the user. For example, the advertisement service provision server may determine the behavioral characteristic of the user, which belongs to the behavioral characteristics of the user derived from the plurality of images and which has been most frequently derived, to be the representative behavioral characteristic of the user, and then may use the representative behavioral characteristic of the user to select at least one target advertisement from a plurality of previously stored advertisements.

Thereafter, the advertisement service provision server selects at least one target advertisement from a plurality of previously stored advertisements based on the derived behavioral characteristic of the user at step S330. More specifically, the advertisement service provision server may extract an advertisement characteristic from each of the plurality of previously stored advertisements, may compare the extracted advertisement characteristic of each of the plurality of previously stored advertisements with the derived behavioral characteristics of the user, and may select at least one target advertisement from the plurality of previously stored advertisements. For example, the advertisement service provision server may check the similarity between the advertisement characteristic of each of the plurality of previously stored advertisements and the derived behavioral characteristic of the user, and may select at least one of the plurality of previously stored advertisements, which has an advertisement characteristic most similar to the derived behavioral characteristic of the user, as the at least one target advertisement. In this case, an algorithm for checking similarity compares at least one behavioral characteristic word, included in the behavioral characteristic of the user, with at least one advertisement characteristic word included in the advertisement characteristic of each of the plurality of previously stored advertisements. Various comparison algorithms may be used as the algorithm for checking similarity. More specifically, when the advertisement characteristic of a first previously stored advertisement is “youth-beverage,” the advertisement characteristic of a second previously stored advertisement is “adult-automobile” and the derived behavioral characteristic of a user is “adult-male,” the advertisement service provision server may select the second advertisement, which has an advertisement characteristic most similar to “adult-male,” i.e., the derived behavioral characteristic of the user, as at least one target advertisement. In this case, the plurality of previously stored advertisements may each include at least one of text, image, sound and moving image forms.

When the plurality of behavioral characteristics of a user has been derived because the number of images stored in a cloud album is plural, the advertisement service provision server may select at least one target advertisement from a plurality of previously stored advertisements based on the representative behavioral characteristic of the user.

Furthermore, the advertisement service provision server may select at least one target advertisement by taking into account the derived behavioral characteristic of a user and the bidding price of each of a plurality of advertisements. Accordingly, the advertisement service provision server may select at least one target advertisement by taking into account the bidding price of each of a plurality of advertisements as well as the derived behavioral characteristics of a user using at least one image stored in a cloud album. For example, the advertisement service provision server may primarily select one or more candidate advertisements by comparing the advertisement characteristic of each of a plurality of previously stored advertisements with the derived behavioral characteristic of a user, and then may secondarily select at least one target advertisement by taking into account the bidding price of each of the selected one or more candidate advertisements.

Furthermore, the advertisement service provision server may receive personal information about a user that is input by the terminal of the user, and then may select at least one target advertisement from a plurality of previously stored advertisements based on the derived behavioral characteristic of the user and the received personal information of the user. Accordingly, the advertisement service provision server may select at least one target advertisement by considering personal information about a user that is directly input by the user, as well as the derived behavioral characteristic of the user, using at least one image stored in a cloud album.

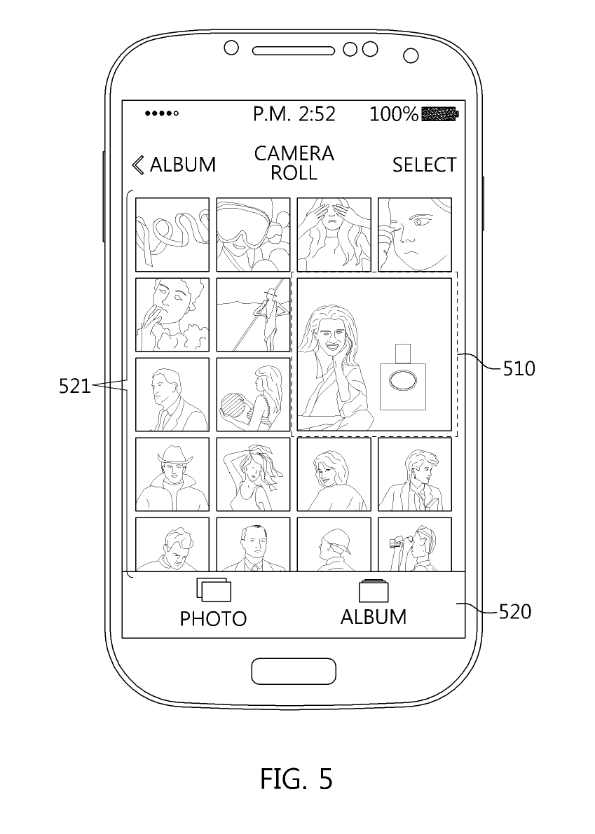

Thereafter, the advertisement service provision server provides the at least one target advertisement to the terminal of the user at step S340. More specifically, the advertisement service provision server may provide the at least one target advertisement to the terminal of the user by displaying the at least one target advertisement via an image view interface supported by the terminal of the user. In this case, the advertisement service provision server may display the at least one target advertisement using at least one of a method of inserting a target advertisement into a thumbnail on the image view interface, a method of inserting a target advertisement between a plurality of images sliding on the image view interface, a method of inserting a target advertisement into a collage on the image view interface, a method of overlaying a target advertisement on an image provided on the image view interface, a method of inserting a target advertisement into at least some region of an image provided by the image view interface, and a method of inserting a target advertisement in a banner form on the image view interface. In this case, the advertisement service provision server may display the at least one target advertisement based on the derived behavioral characteristic of the user. This is described in detail with reference to FIGS. 5 to 8.

Furthermore, the step of providing the at least one target advertisement to the terminal of the user may include the step of storing the at least one target advertisement in the terminal of the user or the step of providing the at least one target advertisement of one or more previously cached advertisements to the terminal of the user. In this case, the one or more advertisements previously cached in the terminal of the user may be one or more advertisements that are selected from a plurality of advertisements to be cached in the terminal of the user. In this case, the advertisement service provision server may enable the process of selecting the at least one target advertisement based on the behavioral characteristic of the user to be performed in the terminal of the user. Accordingly, the advertisement service provision server may provide the at least one target advertisement to the terminal of the user by displaying the stored at least one target advertisement via the image view interface in accordance with the operation of an application installed on the terminal of the user even in the situation in which the terminal of the user has not been connected to the advertisement service provision server via a wireless or wired connection.

Furthermore, although not shown in the drawings, the advertisement service provision server may calculate the capacity of a cloud album corresponding to a user, may determine at least one of the display time, display cycle and number of displays of at least one target advertisement based on the calculated capacity of the cloud album, and then may display the at least one target advertisement via the image view interface based on the result of the determination. For example, if the capacity of the cloud album corresponding to the user is greater than a predetermined reference capacity, the advertisement service provision server may set the display time of at least one target advertisement, provided to the terminal of the user, to be longer than a predetermined reference time, may set the display cycle of the at least one target advertisement to be shorter than a predetermined reference cycle, may set the number of displays of the at least one target advertisement to be greater than a predetermined reference display number, and may display the at least one target advertisement via the image view interface in accordance with the settings.

As described above, the advertisement service provision server according to the present embodiment may derive the behavioral characteristic of a user from at least one image stored in a cloud album corresponding to the user, may select at least one target advertisement from a plurality of previously stored advertisements based on the derived behavioral characteristic of the user, and may provide the at least one target advertisement to the terminal of the user. Accordingly, an advertisement effect can be maximized because the at least one target advertisement suitable for the user is provided.

FIG. 4 is a conceptual diagram showing a process of analyzing at least one image stored in a cloud album according to an embodiment of the present invention.

Referring to FIG. 4, an advertisement service provision server 410 according to an embodiment of the present invention may store at least one image, received from the terminal 420 of a user 421, in a cloud album 430 corresponding to the user 421. In this case, the at least one image stored in the cloud album 430 may be classified as and stored in a folder based on folders configured in the terminal 420 of the user 421 or in response to the input of the user 421. For example, a first image 431 stored in the terminal 420 of the user 421 may be uploaded to the cloud album 430, and may be stored in the person folder 432 of the cloud album 430, as in folders configured in the terminal 420 of the user 421.

In order to derive the behavioral characteristic of the user 421, the advertisement service provision server 410 analyzes at least one image stored in the cloud album 430. More specifically, the advertisement service provision server 410 may recognize at least one of a subject and a background included in the at least one image stored in the cloud album 430, may derive the behavioral characteristic of the user 421 based on the result of the recognition, and may analyze the at least one image stored in the cloud album 430. In the process of recognizing at least one of the subject and the background included in the at least one image stored in the cloud album 430, the advertisement service provision server 410 may use various recognition algorithms, such as a subject and background separation algorithm, a face recognition algorithm, and a place recognition algorithm. Detailed descriptions of the algorithms are omitted because the detailed descriptions of the algorithms depart from the scope of the technical spirit of the present invention.

In this case, the behavioral characteristic of the user may include at least one behavioral characteristic word classified and generated based on predetermined categories. For example, the advertisement service provision server 410 may recognize the subject 433 included in the first image 431 stored in the cloud album 430 using a face recognition algorithm, may classify the subject 433 based on predetermined categories, such as adult, youth, baby, male, and female, and may derive the behavioral characteristic of the user 421 as the behavioral characteristic words “adult-mustache old man-male.”

Furthermore, the advertisement service provision server 410 may recognize at least one of a subject and a background included in the at least one image based on the folder of the cloud album 430 in which at least one image is stored. For example, the advertisement service provision server 410 may analyze the folder of the cloud album 430 in which the at least one image is stored, and may recognize at least one of the subject and the background included in the at least one image based on the result of the analysis. More specifically, the advertisement service provision server 410 may analyze the person folder 432 of the cloud album 430 in which the first image 431 is stored, may identify the folder in which images related to a person are stored, may recognize only the subject 433 without recognizing a background 434 included in the first image 431, and may derive the behavioral characteristic of the user 421 based on the recognized subject 433 as the behavioral characteristic words “adult-mustache old man-male.”

As described above, the derived behavioral characteristic of the user 421 is compared with the advertisement characteristic of each of the plurality of previously stored advertisements, thereby enabling at least one of a plurality of previously stored advertisements, which is suitable for the user 421, to be selected.

FIGS. 5 to 8 are diagrams showing screens of the terminal of a user to which at least one target advertisement is provided according to an embodiment of the present invention.

Referring to FIG. 5 showing a screen on which at least one target advertisement is displayed in such a manner as to be inserted into a thumbnail on an image view interface, at least one target advertisement 510 according to an embodiment of the present invention may be displayed on a screen of the terminal of a user in such a manner that the at least one target advertisement 510 is inserted into a thumbnail 521 on the image view interface 520 of an application supported by the terminal of the user.

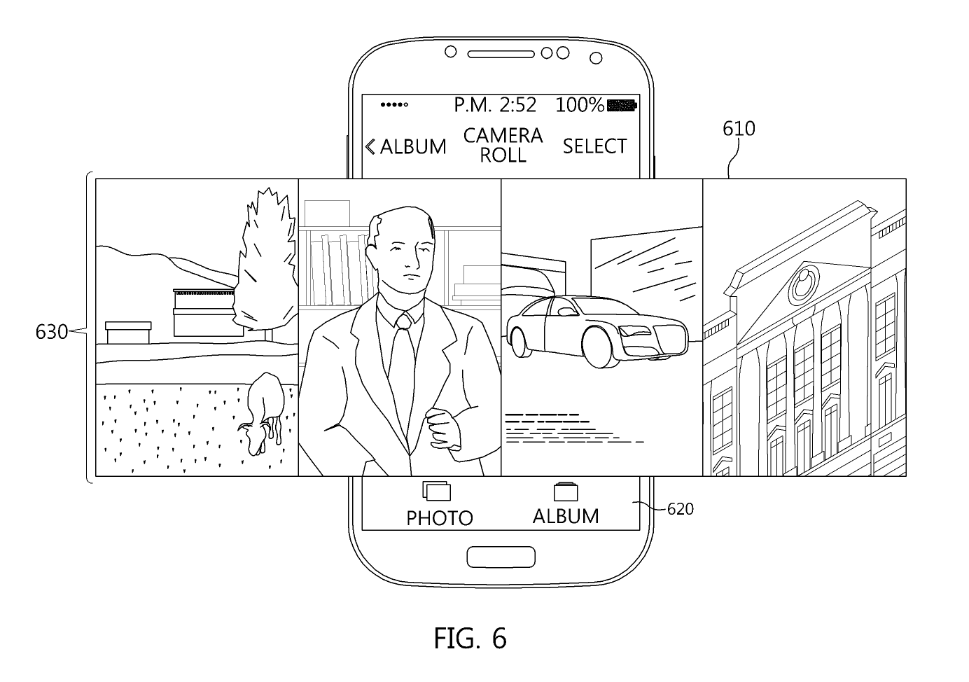

Furthermore, referring to FIG. 6 showing a screen on which at least one target advertisement is displayed in such a manner as to be inserted between a plurality of images sliding on an image view interface, at least one target advertisement 610 according to an embodiment of the present invention may be displayed on a screen of the terminal of a user in such a manner that the at least one target advertisement 610 is inserted between a plurality of images 630 that slide laterally on the image view interface 620 of an application supported by the terminal of the user. Although the plurality of images 630 has been shown as sliding laterally on the image view interface 620, it is not limited thereto. In the same manner, although the at least one target advertisement 610 slides vertically, the at least one target advertisement 610 may be displayed in such a manner as to be inserted between the plurality of images 630 sliding on the image view interface 620.

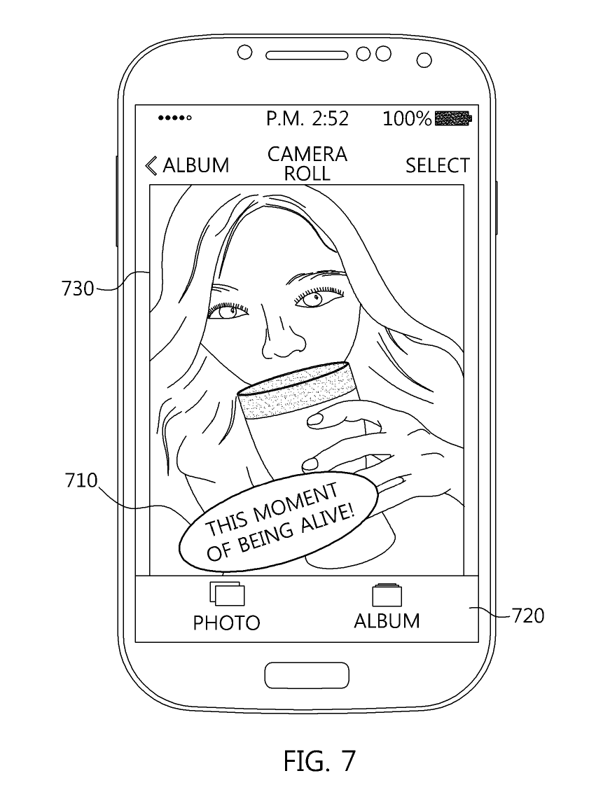

Furthermore, referring to FIG. 7 showing a screen on which at least one target advertisement is displayed in such a manner as to be inserted into at least some region of an image provided on an image view interface, at least one target advertisement 710 according to an embodiment of the present invention may be displayed on a screen of the terminal of a user in such a manner as to be inserted into at least some region of an image 730 provided on the image view interface 720 of an application supported by the terminal of the user. In this case, the advertisement service provision server may insert the at least one target advertisement 710 into at least some region of the image 730 so that it is associated with the image 730. For example, when the at least one target advertisement 710 includes the advertisement characteristic “beer” and the subject of beer is included in the image 730, the advertisement service provision server may insert the at least one target advertisement 710 into at least some region close to the subject of beer included in the image 730. Although the at least one target advertisement has been shown as having a text format, it is not limited thereto. The at least one target advertisement may have an image, sound or moving image format.

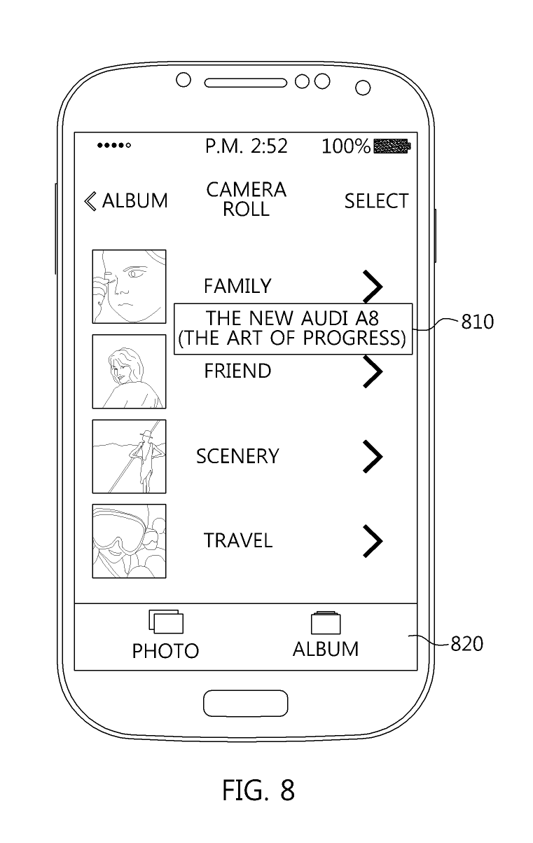

Furthermore, referring to FIG. 8 showing a screen on which at least one target advertisement is displayed in such a manner as to be inserted in a banner form on an image view interface, at least one target advertisement 810 according to an embodiment of the present invention may be displayed on a screen of the terminal of a user in such a manner as to be inserted in a banner form on the image view interface 820 of an application supported by the terminal of the user.

The advertisement service provision server according to an embodiment of the present invention may provide at least one target advertisement to the terminal of a user using various display methods without being limited to or restricted by the aforementioned display methods. In this case, the advertisement service provision server may display the at least one target advertisement based on the derived behavioral characteristic of the user. For example, the advertisement service provision server may determine the most effective one of various display methods that is based on the derived behavioral characteristic of a user, and then may display at least one target advertisement using the most effective method. More specifically, when the behavioral characteristic of a user has been derived as the behavioral characteristic words “adult-male-travel,” background-centric images of travel scenes may be stored in the terminal of the user because of the behavioral characteristic “travel.” Accordingly, since the user chiefly views the background-centric images in the form of thumbnails on the image view interface, the advertisement service provision server may display at least one target advertisement using a method of inserting at least one target advertisement into a thumbnail on the image view interface.

The apparatuses and the components described above may be implemented using hardware components, software components, or combinations thereof. For example, the apparatuses and the components described in conjunction with the embodiments may be implemented using one or more general-purpose or special-purpose computers, such as a processor, a controller, an arithmetic logic unit (ALU), a digital signal processor, a microcomputer, a field programmable array (FPA), a programmable logic unit (PLU), a microprocessor, or any other device capable of responding to and executing instructions. The processing device may run an operating system (OS) and one or more software applications that run on the OS. The processing device also may access, store, manipulate, process, and create data in response to the execution of the software. Although a single processing device has been described as being used for purpose of simplicity, one skilled in the art will appreciate that a processing device may include multiple processing elements and multiple types of processing elements. For example, a processing device may include multiple processors, or a processor and a controller. In addition, different processing configurations, such as parallel processors, may be used.

The software may include a computer program, program code, instructions, or combinations thereof. The software may independently or collectively instruct or configure the processing device so that the processing device operates as desired. The software and the data may be embodied permanently or temporarily in any type of machine, component, physical or virtual equipment, computer storage medium or device, or in signal waves so that the software and the data can provide instructions or data to or can be interpreted by the processing device. The software also may be distributed over network coupled computer systems so that the software is stored and executed in a distributed fashion. In particular, the software and data may be stored by one or more computer readable recording mediums.

The methods according to the embodiments of the present invention may be implemented as a program or a smart phone app that can be executed by various computer means. In this case, the program or smart phone app may be recorded on a computer-readable storage medium. The computer-readable storage medium may include program instructions, data files, and data structures solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. The hardware devices may be configured to operate as one or more software modules in order to perform the operation of the present invention, and the vice versa.

At least one embodiment of the present invention may provide a method of providing advertisement service, which maximizes an advertisement effect by providing at least one target advertisement to a terminal of a user based on the behavioral characteristic of the user which have been derived using a cloud album.

At least one embodiment of the present invention may provide a method of providing advertisement service, which derives the behavioral characteristic of a user by analyzing at least one image stored in a cloud album.

At least one embodiment of the present invention may provide a method of providing advertisement service, which analyzes at least one image based on at least one of a subject and a background included in the at least one image.

At least one embodiment of the present invention may provided a method of providing advertisement service using various display methods in the process of providing at least one target advertisement to a terminal of a user.

Although the present invention has been described in connection with the limited embodiments and drawings, those skilled in the art may make various changes and modifications based on the above description. For example, even when the described technology is performed in an order different from the described one, even when the components of the described system, structure, apparatus or circuit are coupled or combined with each other in a manner different from the described one, and/or even when a component of the described system, structure, apparatus or circuit is replaced with another component or its equivalent, appropriate results may be achieved.

Therefore, other implementations, other embodiments, and equivalents to the attached claims also fall within the scope of the attached claims.

What is claimed is:

1. A method of providing advertisement service using a cloud album executed by a computer, the method comprising:
receiving a stored image from a terminal of a user, and configuring a cloud album corresponding to the user;
analyzing at least one image stored in the cloud album in order to derive a behavioral characteristic of the user;
selecting at least one target advertisement from a plurality of previously stored advertisements based on the derived behavioral characteristic of the user; and
providing the at least one target advertisement to the terminal of the user.

2. The method of claim 1, wherein selecting the at least one target advertisement comprises selecting the at least one target advertisement by taking into account the derived behavioral characteristic of the user and a bidding price of each of the plurality of advertisements.

3. The method of claim 1, wherein analyzing the at least one image stored in the cloud album comprises:
recognizing at least one of a subject and a background included in the at least one image stored in the cloud album; and
deriving the behavioral characteristics of the user based on a result of the recognition.

4. The method of claim 3, wherein deriving the behavioral characteristic of the user based on the result of the recognition comprises classifying the at least one of the recognized subject and background included in the at least one image based on predetermined categories.

5. The method of claim 3, wherein recognizing the at least one of the subject and the background included in the at least one image stored in the cloud album comprises recognizing the at least one of the subject and the background included in the at least one image based on a folder of the cloud album in which the at least one image is stored.

6. The method of claim 1, wherein analyzing the at least one image stored in the cloud album comprises analyzing a folder of the cloud album in which the at least one image is stored.

7. The method of claim 1, wherein providing the at least one target advertisement to the terminal of the user comprises displaying the at least one target advertisement via an image view interface supported by the terminal of the user.

8. The method of claim 7, wherein displaying the at least one target advertisement via the image view interface comprises displaying the at least one target advertisement using at least one of a method of inserting the at least one target advertisement into a thumbnail on the image view interface, a method of inserting the at least one target advertisement between a plurality of images sliding on the image view interface, a method of inserting the at least one target advertisement into a collage on the image view interface, a method of overlaying the at least one target advertisement on an image provided on the image view interface, a method of inserting the at least one target advertisement into at least some region of an image provided on the image view interface, and a method of inserting the at least one target advertisement in a banner form on the image view interface.

9. The method of claim 7, wherein displaying the at least one target advertisement comprises displaying the at least one target advertisement based on the derived behavioral characteristic of the user.

10. The method of claim 7, further comprising calculating a capacity of the cloud album corresponding to the user;
wherein displaying the at least one target advertisement via the image view interface comprises determining at least one of a display time, display cycle, and number of displays of the at least one target advertisement based on the calculated capacity of the cloud album.

11. The method of claim 1, wherein selecting the at least one target advertisement comprises:
extracting an advertisement characteristic of each of the plurality of previously stored advertisements; and
selecting the at least one target advertisement of the plurality of previously stored advertisements by comparing the extracted advertisement characteristic of each of the plurality of previously stored advertisements with the derived behavioral characteristic of the user.

12. The method of claim 1, wherein the plurality of previously stored advertisements has at least one of text, image, sound, and moving image formats.

13. The method of claim 1, wherein providing the at least one target advertisement to the terminal of the user comprises:
storing the provided at least one target advertisement in the terminal of the user; or
providing the at least one target advertisement of at least one previously cached advertisement to the terminal of the user.

14. The method of claim 1, further comprising receiving personal information of the user from the terminal of the user;
wherein selecting the at least one target advertisement comprises selecting the at least one target advertisement from the plurality of previously stored advertisements based on the derived behavioral characteristic of the user and the received personal information of the user.

15. A computer-readable storage medium having stored therein computer-readable program instructions that, when executed by a computer, cause the computer to perform a method, wherein the method comprises:
receiving a stored image from a terminal of a user;
configuring a cloud album corresponding to the user;
analyzing at least one image stored in the cloud album in order to derive a behavioral characteristic of the user;
selecting at least one target advertisement from a plurality of previously stored advertisements based on the derived behavioral characteristic of the user; and
providing the at least one target advertisement to the terminal of the user.
